(19) United States
(12) Patent Application Publication
(10) Pub. No.: US 2019/0025915 A1
(43) Pub. Date: Jan. 24, 2019

(54) HAPTIC VIRTUAL REALITY GLOVE WITH SYSTEMS FOR SIMULATING SENSATIONS OF PRESSURE, TEXTURE AND TEMPERATURE

(71) Applicant: Alyed Yshidoro TZOMPA SOSA, Mexico City (MX)

(72) Inventors: Alyed Yshidoro TZOMPA SOSA, Mexico City (MX); María Del Rubí SALAZAR AMADOR, Puebla (MX); Prudencio Fidel PACHECO GARCÍA, Puebla (MX)

(21) Appl. No.: 16/070,960

(22) PCT Filed: Jan. 22, 2016
(86) PCT No.: PCT/MX2016/050001

§ 371 Date: Jul. 18, 2018

(51) Int. Cl. G06F 3/01

(52) U.S. Cl. CPC G06F 3/014; G06F 3/017; G06F 3/016

(57) ABSTRACT

A haptic glove that allows interaction with elements of a virtual environment as well as the simulation of touch and temperature sensory stimuli in a fast, controlled and safe manner.

### FIELD OF THE INVENTION

The present invention relates to a haptic glove with means for the simulation of interactions with a virtual control interface and more particularly to a haptic glove with means for the simulation of mechanical sensations of pressure, texture and hardness, which also allows to simulate cold and heat tactile sensations in a fast and controlled manner.

### BACKGROUND OF THE INVENTION

At present, the wide diffusion of virtual environments has opened new forms of interaction between the user and the programming interfaces. These interactions can go beyond the simple fact of using a conventional peripheral such as a keyboard or a mouse, and in many cases allow a much more realistic immersion with the recreated formed elements.

Many of the attempts to facilitate the interaction with the virtual elements have opted for the simulation of an immersive visual field, which makes the user believe that he is inside the virtual interface; however, this immersion only remains at a very basic level, since the actions carried out within it are not reflected as stimuli other than the visual ones.

For this reason, in recent years another type of approach has been proposed to allow the sensory immersion of users in virtualized environments, in order to simulate tactile sensations that can be captured by them.

Thus, multiple attempts have been made to provide peripherals that simulate physical interactions with virtualized objects to some degree. The first attempts for it can be found in the controls of videogame systems, which for years have been introducing motors for the simulation of touch and vibrations with simulated objects; however, these controls only allow a very basic degree of interaction to be obtained, since it is not possible to determine which is the nature of the object that generated the stimulus. To solve this, a series of peripherals collectively called “sensory gloves” have been developed, which in addition to feedback to the user with sensations that reveal the presence of a virtual object, also allow interacting with it, by simulating the inherent tactile sensations that it would cause the taking of its real counterpart.

Examples of this type of device are described, for example, in the development entitled “Haptic Glove”, carried out at Cornell University. This development describes a haptic glove programmed to simulate interactions with a virtual environment, these interactions being from tactical and pressure stimuli for the simulation of touch, roughness and size of objects, to the simulation of thermal sensations of heat; however, the glove described, presents serious temperature control failures, one of its major drawbacks being the absence of means for the effective dissipation of the heat generated, so in cases of prolonged use or failure, can occur burn injuries in the hands of the user.

Patent U.S. 20140313022 A1, describes a haptic glove for interaction with virtualized environments, which has a series of haptic actuators for the simulation of pressure, electrical and thermal sensations, as well as means for interaction with IR elements of a screen; however, said glove requires means for the detection of IR signals, thus limiting its field of application to direct interaction with screens emitting said wavelength. In addition to this, there are no means for the effective simulation of cold and/or heat thermal sensations.

U.S. Pat. No. 6,059,506 A, describes an interface for human interaction with virtualized environments, comprising a series of actuators placed in the distal phalanges of a user, said actuators simulate tactile actions, such as pressure. Likewise, the use of said actuators in garments is directly described to simulate sensations of hardness, roughness and in some cases of heat; however, the actuators used are merely mechanical and require a complicated system of pneumatic and hydraulic actuators to operate, which appreciably increases the final dimensions of the proposed device. Added to this, there is no possible way to generate cold sensations and the assertion that the interface can generate heat sensations is merely speculative.

Patent application U.S. 20090120105 A1, describes a device for the haptic feedback of thermal sensations, which can be used in garments in order to simulate the thermal effects of various materials; however, the described device does not allow to generate tactile stimuli.

U.S. Pat. No. 7,830,361 B2, describes a haptic interface to be used in conjunction with video systems, such as video games, which has means to simulate the sensory perception of touch and temperature. Said interface in the preferred embodiment is directly applied to a conventional game controller and it is also described that the interface can be placed in other peripherals such as a glove. However, the proposed interface uses a heat exchanger system that uses a carrier fluid for cooling the interface, so it is not used as a simulation element for thermal stimuli, but rather as a comfort element.

The aforementioned devices lack adequate means for the generation of cold thermal stimuli, since it is not possible to adequately control the operation of the heating mechanisms used, giving rise to cases in which, even when it is possible to generate heat, this can not be efficiently dissipated, so the residual heat interferes with the glove cooling system. Moreover, it is not possible to combine multiple stimuli in the same region of the glove, since it is very difficult to place the tactile and temperature stimulus generating systems in the same location, due largely to the problems of heat dissipation because its closeness and confinement within the internal surfaces of the glove.

In view of the above problems, there is a need to provide a haptic glove for the simulation of tactile and thermal sensations, which can generate at the same time cold and heat sensations quickly, through a single element, without the need to require of separate control systems. In addition to the above, there is a need that the simulation of tactile and thermal sensations to occur at the same time and over the same stimulation region, in order to provide a much more immersive experience.

### SUMMARY OF THE INVENTION

In order to overcome the disadvantages of the available haptic gloves, the present invention aims to provide a haptic glove with means for the simulation of touch and temperature sensory stimuli in a fast and safe way.

A particular object of the present invention is to provide a haptic glove that allows to simulate cold and heat thermal sensations with the same element and, also has means for the dissipation of excess heat or cold.

Another object of the present invention is to provide a haptic glove of sensory stimuli simulation, which allows to simulate textures, vibrations and touch, at the same time that relates said variables with the physical simulation of a virtualized object.

A further object of the present invention is to provide a haptic glove that allows to simulate changes in temperature almost instantaneously.

A further object of the present invention is to provide a haptic glove with elements for simulating touch and temperature sensations that can be placed together, in a flexible manner, in the same user hand region.

The aforementioned objects, as well as others and the advantages of the present invention, will become apparent from the following detailed description thereof.

### DESCRIPTION OF THE FIGURES OF THE INVENTION

FIG. 1 shows a general diagram of the arrangement of the elements that make up the haptic glove of the present invention.

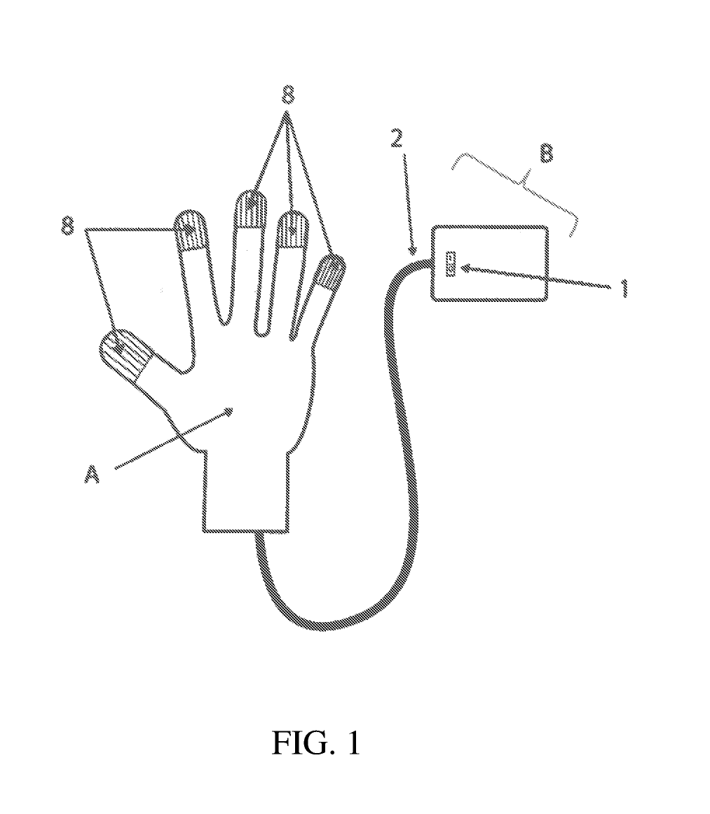

FIG. 2 shows one of the terminals (10) of the present invention.

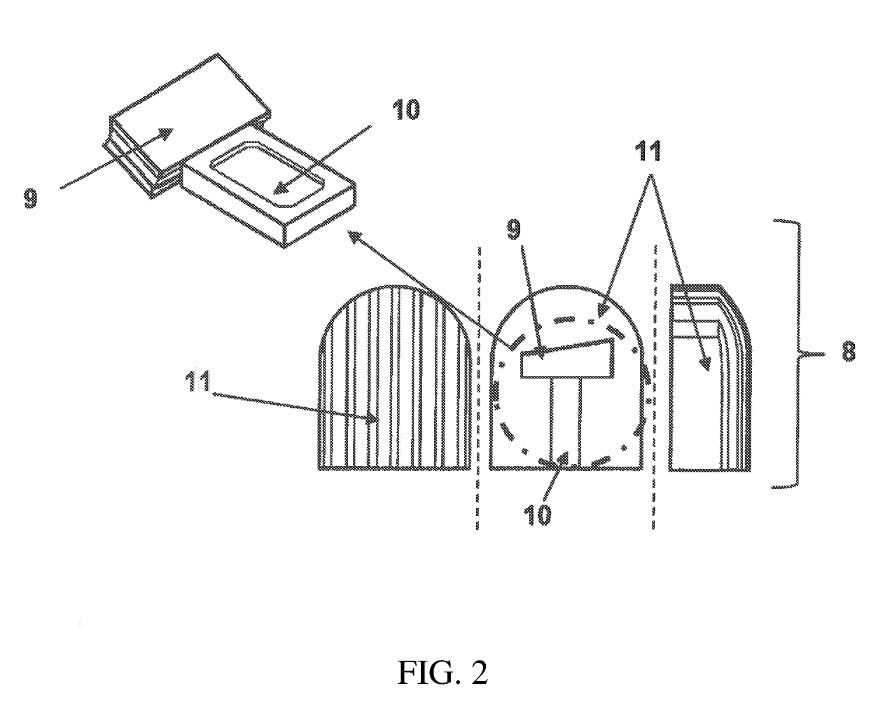

FIG. 3 shows a block diagram showing all the components of the haptic glove of the present invention.

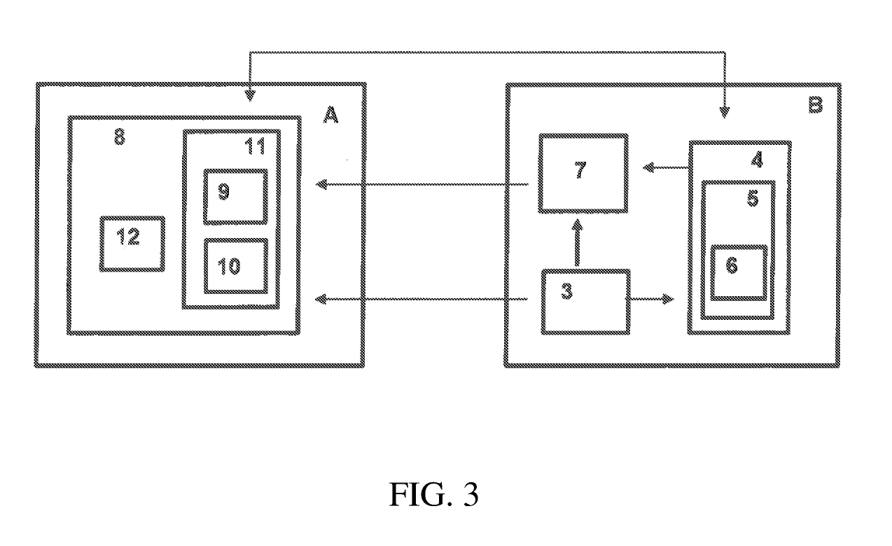

### DETAILED DESCRIPTION OF THE INVENTION

The present invention refers to a haptic glove that allows to interact with a virtual environment, with means for the simulation of touch, vibration and roughness sensations and that in addition to the above, allows to generate cold/heat sensations quickly and safely, allowing the controlled dissipation of excess heat.

To achieve the above, the haptic glove of the present invention uses a series of control mechanisms that allow to simulate in a controlled and realistic way, interactions with the virtual environment that allow to carry out a much more realistic immersion with simulated objects, which goes beyond its simple manipulation.

The haptic glove of the present invention is constituted by a glove (A), of textile material or any other suitable material (for example but not limited to: neoprene, leather or bakelite), which adapts anatomically to the contours of the user hand and, which serves as an anchoring point for the other electronic components and; a control module (B) that contains the appropriate means to supply energy to the other components of the glove as well as the electronic components necessary to carry out the simulation of sensations. Said module (B) will be described in more detail below.

### Control module (B)

The control module (B), consists of a housing (1), with a power supply (3) that allows to supply the voltage and currents necessary for the operation of all the components of the glove, as well as the necessary electronic components for carry out the simulation of sensations, said voltage and current required by the system being comprised between 3-7 volts and between 10-13 amperes respectively, which are provided by the power supply (3), either through its connection with a conventional power line or, through a battery bank; an output cable (2) for redirecting the voltage and currents produced by the power supply (3); a control card (4) where a series of instructions for the management and control of the other electronic components that make up the sensory simulation systems are preloaded; said control card (4), comprises a central storage unit (5) where a control means (6) are stored for the interpretation of variables and generation of signals; a plurality of drivers (7), which modify the received current according to the instructions generated by the control means (6) and; a plurality of thimble type terminals (8), which are connected to the control card (4) and to the plurality of drivers (7) through the output cable (2), comprising each of said terminals (8), a Peltier cell (9) for the generation of cold and heat sensations, a Voice Coil actuator (10) for the generation of tactile sensations and, a heat dissipating structure (11), adapted to serve as an anchor point for the Peltier cell (9) and the Voice Coil actuator (10). Said heat dissipating structure (11), allows the effective dissipation of the residual heat produced during the operation of the Peltier cell (9), which allows it may operate at the same time as an generation element of the cold and heat thermal sensations, by dissipating the heat produced on the opposite surface of the same during the cold generation event; in this way, the Peltier cells (9) of the terminal (8), by means of the current variations coming from the drivers (7), can act at the same time as an generation element of heat and cold thermal stimuli. On the other hand, the Voice Coil actuators (10), allow to generate at the same time the touch, vibration and roughness sensations by means of the variation of the generated frequencies, being the sensation of simulated roughness, generated by a frequency of between 100-500 Hz, that of vibration between 11-100 Hz and that of touch by means of a ladder signal.

Each of the terminals (8), is located inside the glove (A), in the area corresponding to the distal phalanges (fingertips), in order to be in the most appropriate location for the reception of tactile and thermal stimuli generated to the user.

On the other hand, and in conjunction with the terminals (8), the glove (A), comprises a temperature sensor (12), adapted to measure the operating temperature of the haptic glove and send signals to the control card (4), in order to maintain an exact record of each of the terminals (8) to avoid injuries due to overheating of the glove components.

In a preferred embodiment of the present invention, the housing (1) of the control module (B) is in a location independent of the glove (A), being connected thereto by a communication cable; while in another of its modalities, said casing (1) forms an integral part of the glove (A), being connected by means of a cable in the region of the back of the hand.

The haptic glove described above can serve as a control interface for a virtual environment, for which it is only necessary to incorporate in it conventional position sensors and accelerometers to determine its relative position with respect to a virtual coordinate system.

The glove of the present invention is also useful as a rehabilitation element in therapies for restoring cognitive functions, such as in therapy to treat neurodegenerative disorders or in therapies where the restitution of sensory functions is sought, such as that given after replantation of a finger or after healing of a fracture.

Moreover, the glove of the present invention can also be used as a peripheral for the control of a conventional video game system, allowing to simulate touch and heat sensations received by its virtual avatar, thus increasing its immersion in the game.

The present invention has been described according to a preferred embodiment; however, it will be apparent to a technician with average knowledge in the art that may be made modifications to the invention without departing from its spirit and scope.

1. A haptic glove for interaction with elements of a virtual programming environment and with means for the simulation of sensory stimuli, characterized in that it comprises:
a) A glove (A), which adapts anatomically to the contours of the user hand and serves as an anchoring point for electronic components; and
b) A control module (B), with a housing (1), having inside it a power supply (3) that supplies a suitable voltage and current for the operation of the haptic glove components as well as the electronic components necessary to carry out the simulation of sensations; an output cable (2) for redirecting the voltage and currents produced by the power supply (3); a control card (4) with a central storage unit (5) with control means (6) for the interpretation of variables and generation of signals; a plurality of drivers (7) that modify the received current according to the instructions generated by the control means (6) and; a plurality of terminals (8), located inside the glove (A), connected to the control card (4) and to the plurality of drivers (7) through the output cable (2), with a Peltier cell (9) for the generation of cold and heat sensations, a Voice Coil actuator (10) for the generation of tactile sensations and a heat dissipating structure (11) that serves as the anchor point of the Peltier cell (9) and the Voice Coil actuator (10), at the same time as it dissipates excess heat from said Peltier cell, in such a way that when the control means (6) of the control card (4) generate a signal from the interpretation of introduced variables, said signal is used to control the current in the drivers (7) and send it to the Peltier cells (9), to heat or cool them, the remaining heat being dissipated by the heat sink (11) and/or; to activate the Voice Coil actuators (10) to generate a suitable frequency to simulate touch, vibration and roughness tactile stimuli.

2. The haptic glove according to claim 1, characterized in that the glove (A) is made of a textile material or of any other material selected from group consisting of neoprene, leather, bakelite or a combination thereof.

3. The haptic glove according to claim 1, characterized in that the power supply module produces an output voltage between 3-7 volts and a current between 10-13 amperes.

4. The haptic glove according to claim 1, characterized in that the power source (3) obtains its energy from a connection to a conventional power line or a battery bank.

5. The haptic glove according to claim 1, characterized in that the terminals (8) are located in the area corresponding to the distal phalanges.

6. The haptic glove according to claim 1, characterized in that it also comprises a temperature sensor (12), adapted to measure the operating temperature of the haptic glove and send signals to the control card (4), to maintain an exact control of each of the terminals (8).

7. The haptic glove according to claim 1, characterized in that the casing (1) of the control module (B), is located in a location independent of the glove (A), both of which are connected to each other by means of a communication cable.

8. The haptic glove according to claim 1, characterized in that the casing (1) of the control module (B) forms an integral part of the glove (A), being connected by a cable in the region of the back of the hand.

9. The haptic glove according to claim 1, characterized in that it also comprises position sensors and accelerometers to determine their relative position with respect to a virtual coordinate system.

10. The haptic glove according to claim 1, characterized in that it is used as control interface of a virtual environment; as a rehabilitation tool or; as a peripheral of a video game system.
